(19) United States
(12) Patent Application Publication
(10) Pub. No.: US 2012/0269938 A1
(43) Pub. Date: Oct. 25, 2012

(54) PATTY-FORMING TOOL AND METHOD FOR FORMING STUFFED PATTIES

(76) Inventors: George McConnell Davison, III, Pittsburgh, PA (US); Peter Arthur Meier, Pittsburgh, PA (US); Jason Reed Rogge, Belle Vernon, PA (US); Colin Derek Curry, Allison Park, PA (US); Matthew David McClatchey, Hamburgh, NY (US); Chad Brewer, Linn Creek, MO (US); William Whitlock, Linn Creek, MO (US)

(21) Appl. No.: 13/090,923

(22) Filed: Apr. 20, 2011

(51) Int. Cl. A22C 7/00; A23P 1/10; B28B 1/44

(52) U.S. Cl. 426/280; 425/278; 426/279

(57) ABSTRACT

A tool for forming stuffed patties includes a base defining a cavity, a lid coupled to the base, and a stamp coupled to the lid. The lid is movable relative to the base between a closed position in which the cavity is substantially closed, and an open position in which the cavity is substantially open. The stamp is movable relative to the lid when the lid is in the closed position to reduce a volume of the cavity.

### BACKGROUND

The present invention relates to a tool for making patties, such as meat patties, that are stuffed with additional ingredients.

### SUMMARY

In one aspect, the invention provides a tool for forming stuffed patties that includes a base defining a cavity, a lid coupled to the base, and a stamp coupled to the lid. The lid is movable relative to the base between a closed position in which the cavity is substantially closed, and an open position in which the cavity is substantially open. The stamp is movable relative to the lid when the lid is in the closed position to reduce a volume of the cavity.

In another aspect, the invention provides a tool for forming stuffed patties. The tool includes a base defining a cavity and a lid coupled to the base. The lid is movable between a closed position in which the cavity is substantially closed, and an open position in which the cavity is substantially open. A stamp is movable with the lid and configured to extend into the cavity when the lid is in the closed position. A patty support is removably received in the base and includes a support portion and a handle.

In another aspect, the invention provides a method of using a patty-forming tool to prepare a stuffed patty. A patty support is placed into a cavity defined by a base of the tool, and a lower patty portion is placed into the cavity on the patty support. A pocket is formed in the lower patty portion positioned in the cavity. At least one filling ingredient is placed into the pocket of the lower patty portion. An upper patty portion is placed over the lower patty portion in the cavity. A lid of the tool is closed to substantially close the cavity, the lid having a stamp movably coupled thereto. A stamp actuator is pressed to move the stamp relative to the lid to reduce a volume of the cavity, thereby bearing on the upper patty portion to amalgamate the upper and lower patty portions and the at least one filling ingredient into a stuffed patty.

Other aspects of the invention will become apparent by consideration of the detailed description and accompanying drawings.

### BRIEF DESCRIPTION OF THE DRAWINGS

FIG. 1 is an exploded assembly view of a patty-forming tool according to one aspect of the invention.

FIG. 2A is a perspective view of the patty-forming tool of FIG. 1.

FIG. 2B is a side view of the patty-forming tool of FIG. 1.

FIG. 3A is a perspective view of the underside of a stamp of the patty-forming tool of FIG. 1.

FIG. 3B is a side view of the stamp of the patty-forming tool of FIG. 1.

FIG. 4A is a perspective view of the underside of a pocket press of the patty-forming tool of FIG. 1.

FIG. 4B is a side view of the pocket press of the patty-forming tool of FIG. 1.

FIG. 5A is a perspective view of the underside of a removable patty support of the patty-forming tool of FIG. 1.

FIG. 5B is a side view of a removable patty support of the patty-forming tool of FIG. 1.

FIG. 6 is a perspective view illustrating the insertion of a lower patty portion into the patty-forming tool of FIG. 1.

FIG. 7 is a perspective view illustrating the use of the pocket press of FIGS. 5A and 5B to form a pocket in the lower patty portion.

FIG. 8 is a perspective view illustrating the pocket formed in the lower patty portion.

FIG. 9 is a perspective view illustrating the insertion of additional “stuffing” ingredients into the pocket of the lower patty portion while positioned in the patty-forming tool of FIG. 1.

FIG. 10 is a perspective view illustrating an upper patty portion being overlaid upon the lower patty portion in the patty-forming tool of FIG. 1.

FIG. 11 is a perspective view illustrating the depression of a stamp actuator, after the lid is closed, to amalgamate the upper and lower patty portions in the patty-forming tool of FIG. 1 to form a stuffed patty.

FIG. 12 is a perspective view illustrating the removal of the stuffed patty from a cavity of the patty-forming tool with the removable patty support.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways.

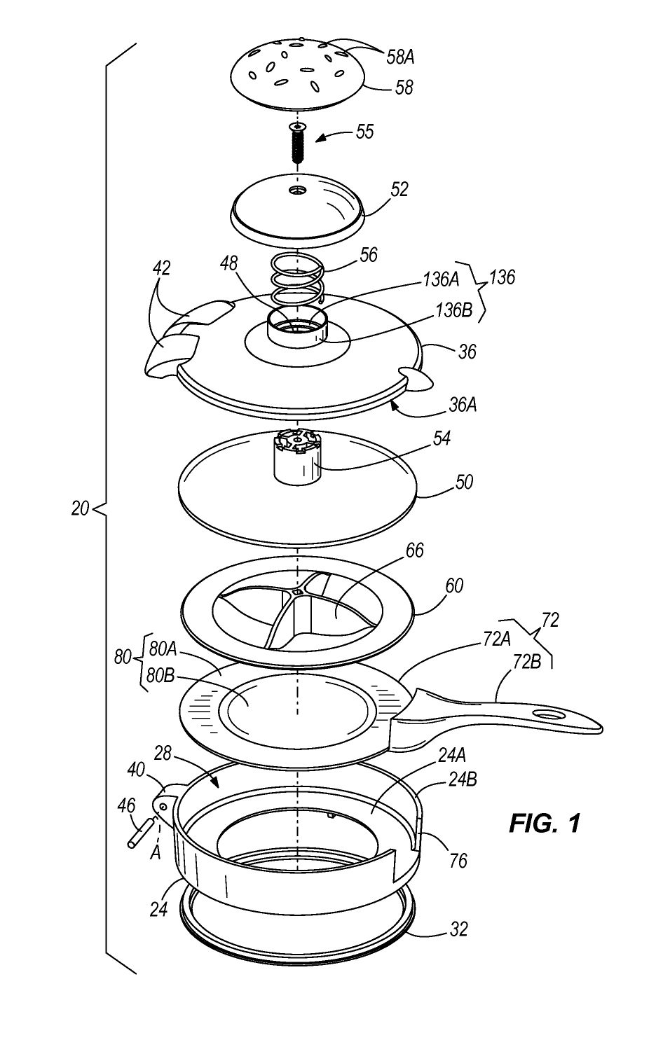

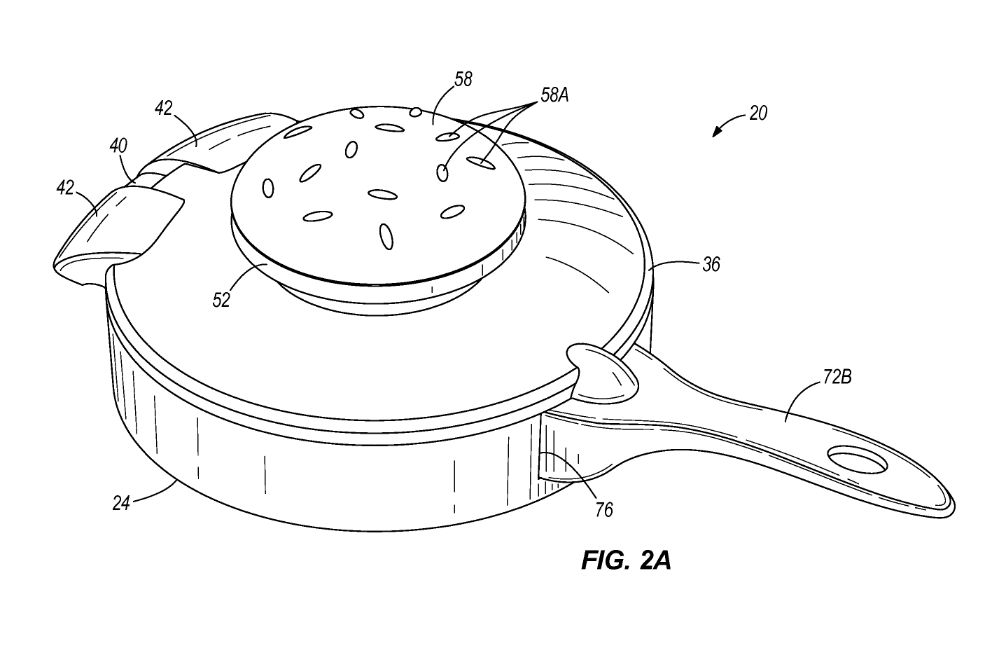

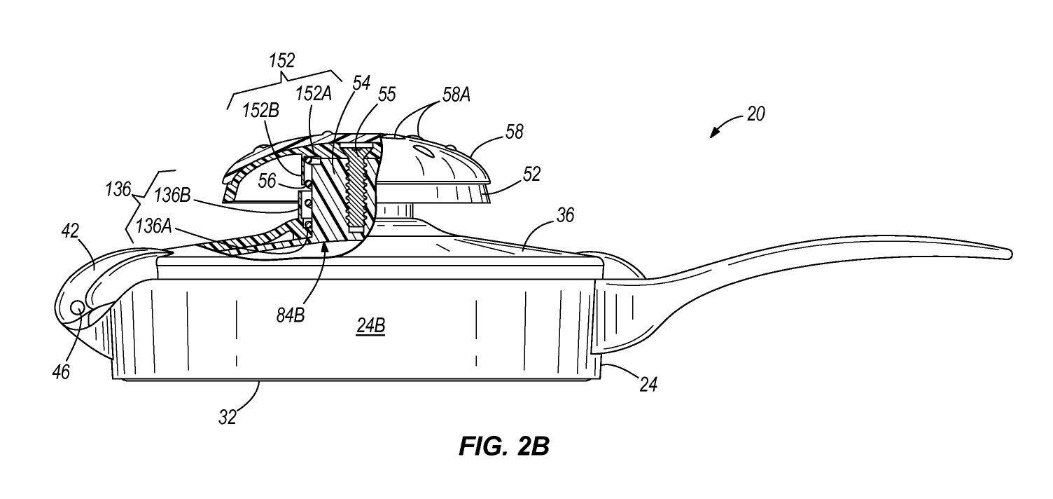

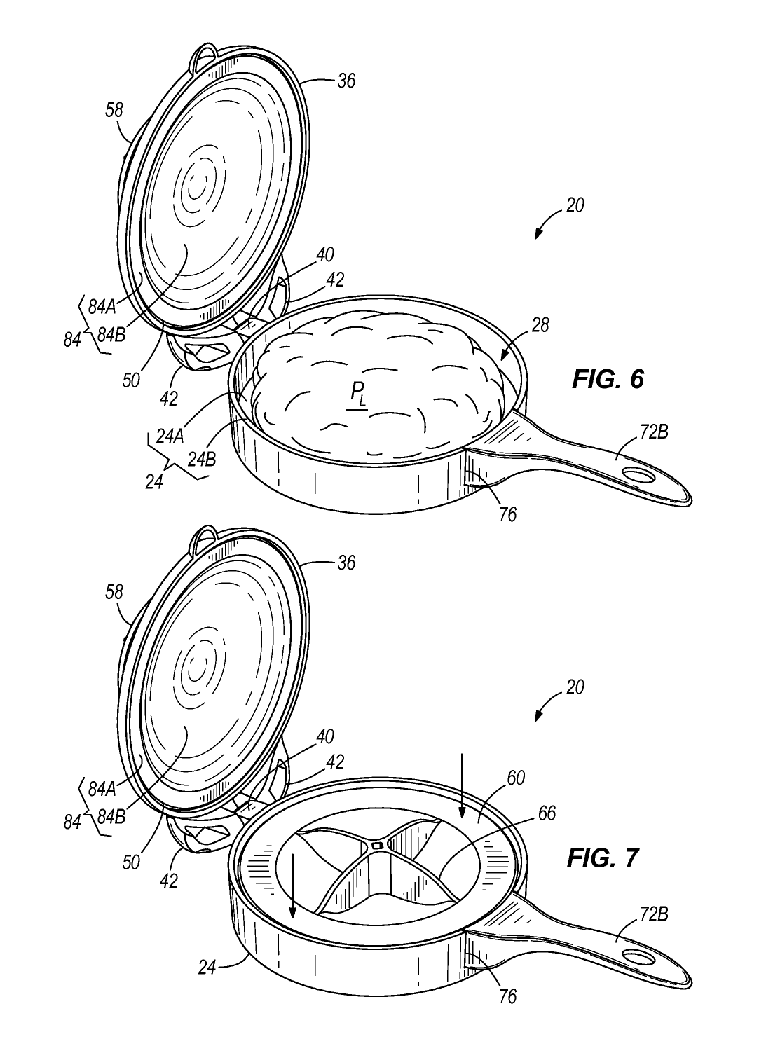

A tool 20 for making a stuffed patty is illustrated in FIGS. 1-2B. The tool 20 includes a base 24 that defines a cavity 28. For example, in the illustrated construction, the base 24 includes a partial lower wall 24A and a transverse, upstanding wall 24B that combine to define the cavity 28. In other constructions, the lower wall 24A may extend fully across the base 24, or there may be no lower wall whatsoever (e.g., the base 24 can cooperate with a table or other working surface to receive a patty). Regardless of the configuration of the lower wall 24A, or the lack thereof, the base 24 defines the cavity 28 by way of at least the upstanding wall 24B. In the illustrated construction, the upstanding wall 24B and the cavity 28 defined thereby are generally cylindrical. However, the cavity 28 can be configured in other shapes. A non-slip ring 32 (e.g., thermoplastic rubber) is coupled to the bottom of the lower wall 24A of the base 24. A lid 36 is coupled to the base 24 and is movable relative to the base 24 between a closed position (FIGS. 2A and 2B) in which the cavity 28 is substantially closed, and an open position (FIGS. 6-10) in which the cavity 28 is substantially open. Closing the cavity 28 with the lid 36 should be understood as meaning substantially closing an otherwise open side (e.g., an open top) of the cavity 28, and does not require that the cavity 28 be fully enclosed or sealed when the lid 36 is closed. In the illustrated construction, the lid 36 is pivotally coupled to the base 24 via a joint formed by an apertured boss 40 of the base 24, a pair of apertured bosses 42 of the lid 36, and a pin 46 extending through the apertured bosses 40, 42. The pivot joint defines a pivot axis A that is concentric with the pin 46. As shown in FIG. 1, the lid 36 includes a central aperture 48.

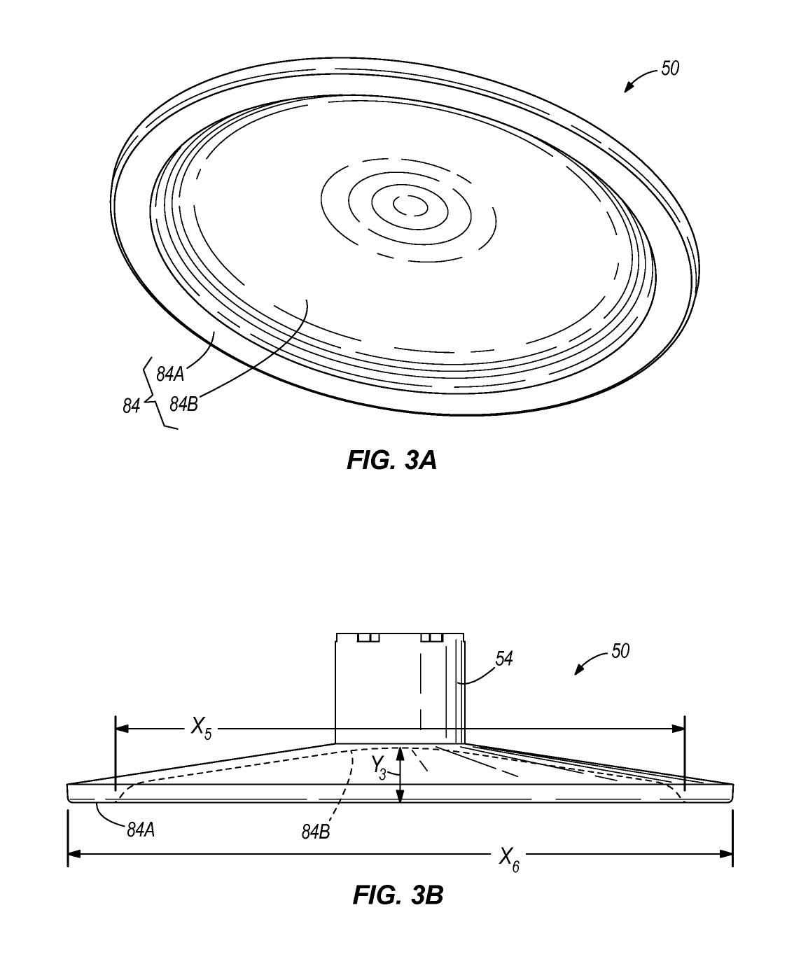

The lid 36 is part of a lid assembly that further includes a stamping assembly having a stamp 50 (FIGS. 3A and 3B) movably coupled to the lid 36, and a stamp actuator 52 fixedly coupled to the stamp 50. The stamp 50 is positioned mainly on an interior side 36A of the lid 36 that faces the cavity 28 when the lid 36 is closed. An extension boss 54 of the stamp 50 extends through the aperture 48 in the lid. The stamp actuator 52 is fixedly coupled to the extension boss 54 of the stamp 50 with a fastener 55, such as a screw, in the illustrated construction, although other suitable fastening means may be substituted. The stamp 50 and the stamp actuator 52 are biased so that the stamp 50 is urged toward the interior side 36A of the lid 36 when the stamp actuator 52 is not being depressed. In the illustrated construction, a compression spring 56 is positioned between the lid 36 and the stamp actuator 52 to bias the stamp 50 toward the interior side 36A of the lid 36. For example, the lid 36 and the stamp actuator 52 can be provided with respective spring interface structures 136, 152 as shown in FIG. 2B. In the illustrated construction, the spring interface structure 136 of the lid 36 includes a ridge or shoulder 136A adjacent the central aperture 48 and a cylindrical guide wall 136B extending upwardly from the lid 36 toward the stamp actuator 52. The shoulder 136A and the guide wall 136B cooperate to define a spring cup for receiving one end of the spring 56. Furthermore, the spring interface structure 152 of the stamp actuator 52 includes a transverse interior wall 152A and cylindrical guide wall 152B extending downwardly therefrom. The two walls 152A, 152B cooperate to define a spring cup for receiving the other end of the spring 56. However, spring cups may be formed by other structures, and the spring 56 can be positioned between any outer-facing surface of the lid 36 (i.e., a surface facing upward when the lid 36 is closed) and any inner-facing surface of the stamp actuator 52 (i.e., a surface facing downward when the lid 36 is closed).

The position to which the stamp 50 is biased is referred to as the non-compressed position. The stamp 50 is reciprocable relative to the lid 36 between the non-compressed position and a compressed position. To move the stamp 50 from the non-compressed position to the compressed position, the stamp actuator 52 is pressed to overcome the bias provided by the spring 56. When the lid 36 is in the closed position, the stamp 50 reduces the volume of the cavity 28 as the stamp 50 is moved from the non-compressed position to the compressed position.

As shown in FIGS. 1-2B, a cover 58 can be coupled to the stamp actuator 52. The cover 58 can be coupled to the stamp actuator 52 via a fastener-less snap fit for secure lifetime assembly, although other couplings, including those that enable easy removal for service or disassembly, can be used. The cover 58 may be configured with an ergonomic and aesthetically-pleasing form. In the illustrated construction, the cover 58 is shaped like the top of a hamburger bun, complete with a sesame seed pattern 58A.

In other constructions, the stamp 50 can be movably coupled to the lid 36 in another manner, and can be configured to reciprocate or exhibit an alternate type of movement to compress a patty for final forming. In some constructions, the stamp 50 may be integrally-formed as one piece with the lid 36, or separately-formed from the lid 36 but fixedly coupled to the lid 36, and in such constructions the stamp 50 may be configured to compress a patty for final forming by simply closing the lid 36.

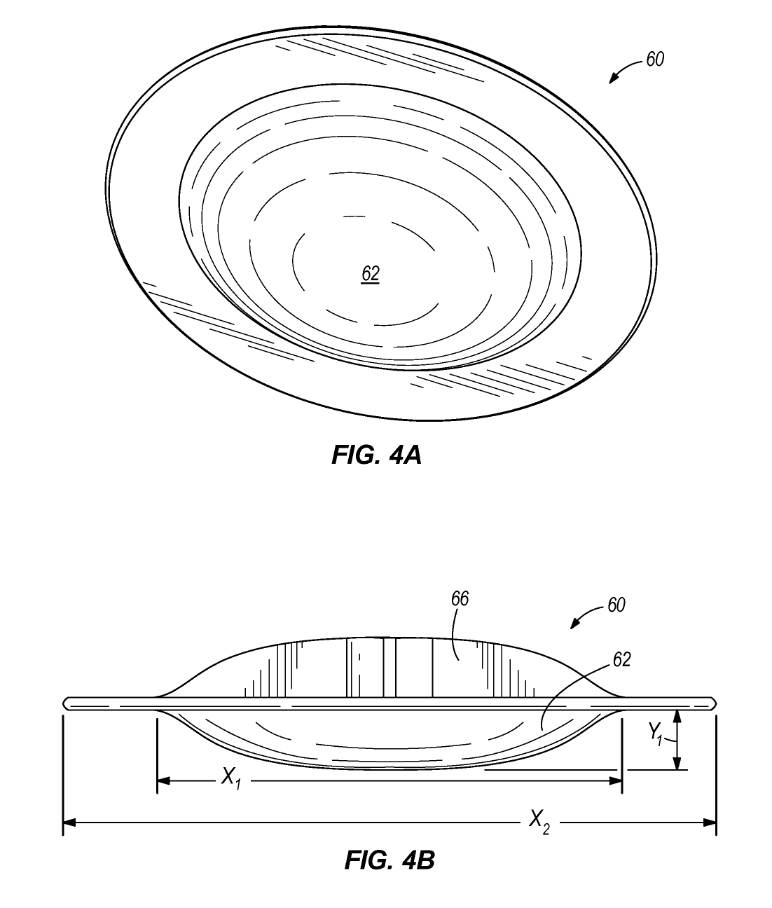

The tool 20 further includes a pocket press 60 (FIGS. 4A and 4B). In the illustrated construction, the pocket press 60 is separate from the base 24 and the lid 36 (i.e., not formed with or coupled to the base 24 or the lid 36), and is generally disc-shaped. The pocket press 60 has a shape generally corresponding to that of the upstanding wall 24B of the base 24, and has an outer dimension (e.g., diameter) that is slightly smaller than an inner dimension (e.g., diameter) of the upstanding wall 24B. When not in use, the pocket press 60 can be stored in the cavity 28. The pocket press 60 has a first side including a convex portion 62 movable into the cavity 28, when pliable foodstuffs are present, to form a pocket or depression in the foodstuffs positioned in the cavity. In the illustrated construction, the convex portion 62 is a central bulge that extends from the first side of the pocket press 60. The crosswise dimension X₁ of the convex portion 62 is between about 50 percent and about 80 percent of the total crosswise dimension X₂ of the pocket press 60. The depth Y₁ of the convex portion 62, measured perpendicular to the crosswise direction, is between about 5 percent and about 20 percent of the crosswise dimension X₁ of the convex portion 62. The pocket press 60 also has a second side, opposite the first side, that includes a grip portion 66. In the illustrated construction, the grip portion 66 is formed from cruciform upstanding walls. Although the pocket press 60 offers the substantial convenience of an all-in-one package for forming stuffed patties, according to the method described in detail below, the tool 20 may be provided without the pocket press 60 in some constructions.

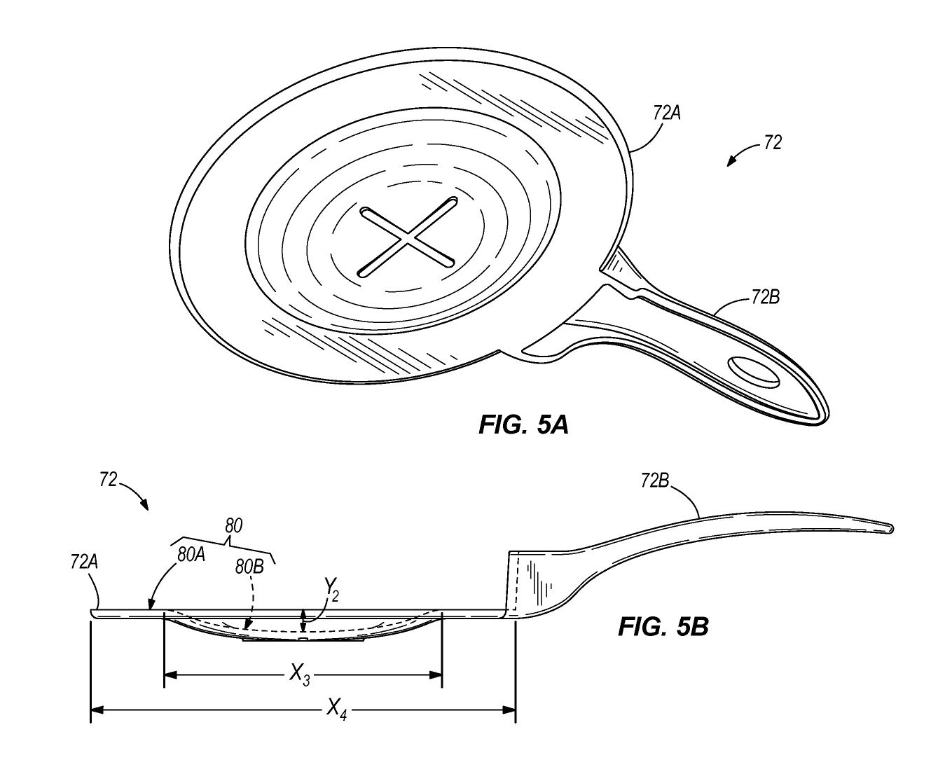

The tool 20 further includes a patty support 72 (FIGS. 5A and 5B). The patty support 72 includes a support portion 72A and a handle portion 72B coupled to the support portion 72A and extending therefrom. At least the support portion 72A of the patty support 72 is removably received in the base 24 and configured to support the foodstuffs positioned in the cavity 28. However, the patty support 72 is separate from the base 24 (i.e., not formed with or coupled to the base 24) in the illustrated construction. When the support portion 72A is positioned inside the cavity 28 of the base 24, the handle portion 72B extends outside the cavity 28 through a notch 76 formed in the upstanding wall 24B of the base 24. The patty support 72, particularly the support portion 72A, includes an upper surface 80 for receiving and supporting the foodstuffs for making a patty. At least a portion of the upper surface 80 is concave. In the illustrated construction, the upper surface 80 is generally disc-shaped, like the pocket press 60, and includes a generally flat rim portion 80A and a concave central portion 80B. The crosswise dimension X₃ of the concave central portion 80B is about the same as the crosswise dimension X₁ of the convex portion 62 of the pocket press 60, and the overall crosswise dimension X₄ of the support portion 72A is about the same as the crosswise dimension X₂ of the pocket press 60. However, the depth Y₂ of the concave central portion 80B of the patty support's upper surface 80 is less than the depth Y₁ of the convex portion 62 of the pocket press 60. For example, the depth Y₂ may be only about half of the depth Y₁.

Returning to the stamp 50 of the lid assembly, the stamp 50 has a stamping surface 84 facing generally away from the lid 36, and toward the cavity 28 when the lid 36 is in the closed position. Like the upper surface 80 of the patty support 72, at least a portion of the stamping surface 84 is concave. The stamping surface 84 includes a rim portion 84A and a concave central portion 84B. The rim portion 84A can be substantially flat or generally concave, but if concave, the rim portion 84A is significantly flatter than the concave central portion 84B. In some constructions, the stamping surface 84 is not formed with a separate rim portion 84A, but rather the entire stamping surface 84 is generally concave, either uniformly concave or increasingly flat toward the outer edge. In some constructions including a separate rim portion 84A, the concave central portion 84B has a crosswise dimension X₅ that is about 80 to 90 percent of the overall crosswise dimension X₆ of the stamping surface 84. The depth Y₃ of the concave central portion 84B is greater than the depth Y₂ of the concave central portion 80B of the patty support's upper surface 80 and about equal to the depth Y₁ of the convex portion 62 of the pocket press 60, but other configurations may also be provided.

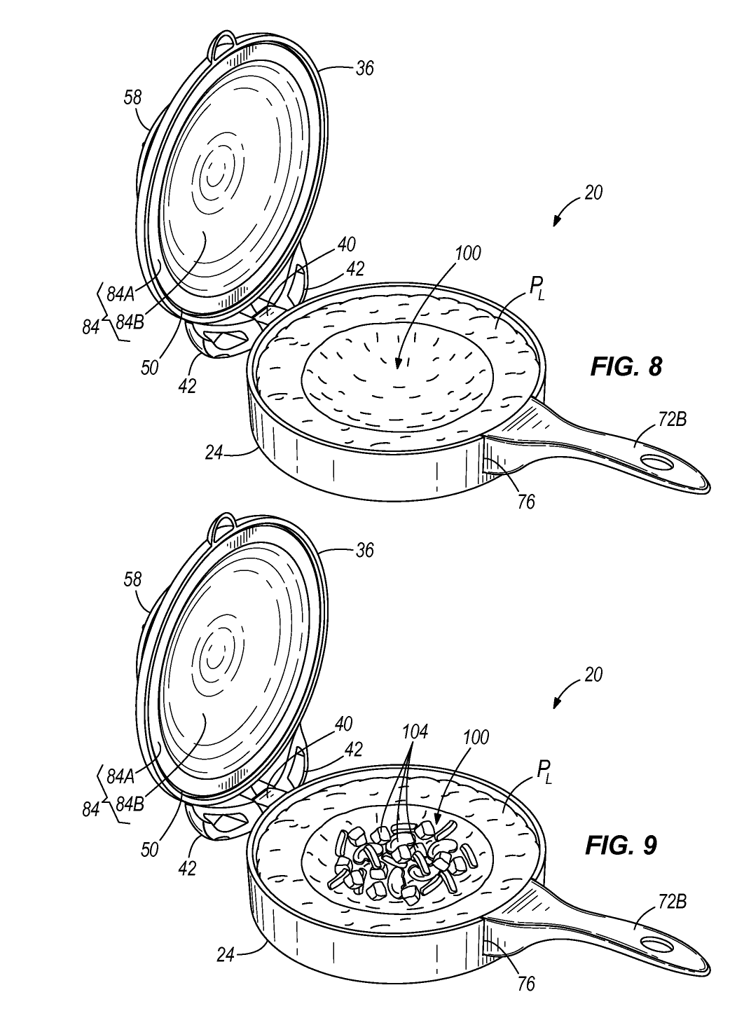

A method of using the tool 20 to make a stuffed patty (e.g., a stuffed hamburger patty) is described below with particular reference to FIGS. 6-12. As shown in FIG. 6, the patty support 72 is positioned within the base 24, and a lower patty portion P_{L} is placed into the cavity 28, on the upper surface 80 of the patty support 72. The lower patty portion P_{L} can be made up of ground meat such as beef, but patty-formable foods other than ground beef may also be used with the tool 20. The lower patty portion P_{L} may be configured to make up about one-half of a finished patty P (e.g., the lower patty portion P_{L} may be about 2-3 ounces). It should be noted that the lower patty portion P_{L} need not be meticulously formed prior to insertion into the tool 20. As shown in FIG. 7, the pocket press 60 is grasped by the user and pressed onto the top of the lower patty portion P_{L} in the cavity 28. The pocket press 60 causes the lower patty portion P_{L} to expand toward the upstanding wall 24B, while also forming a pocket or depression 100 in the top central portion of the lower patty portion P_{L} (FIG. 8). Due to the concave central portion 80B of the patty support 72 underneath the lower patty portion P_{L}, the lower surface of the lower patty portion P_{L} is allowed to assume somewhat of a convex shape when pressed by the pocket press 60. It should also be appreciated that the pocket 100 in the lower patty portion P_{L} can be formed by hand, or with another utensil, such as a spoon.

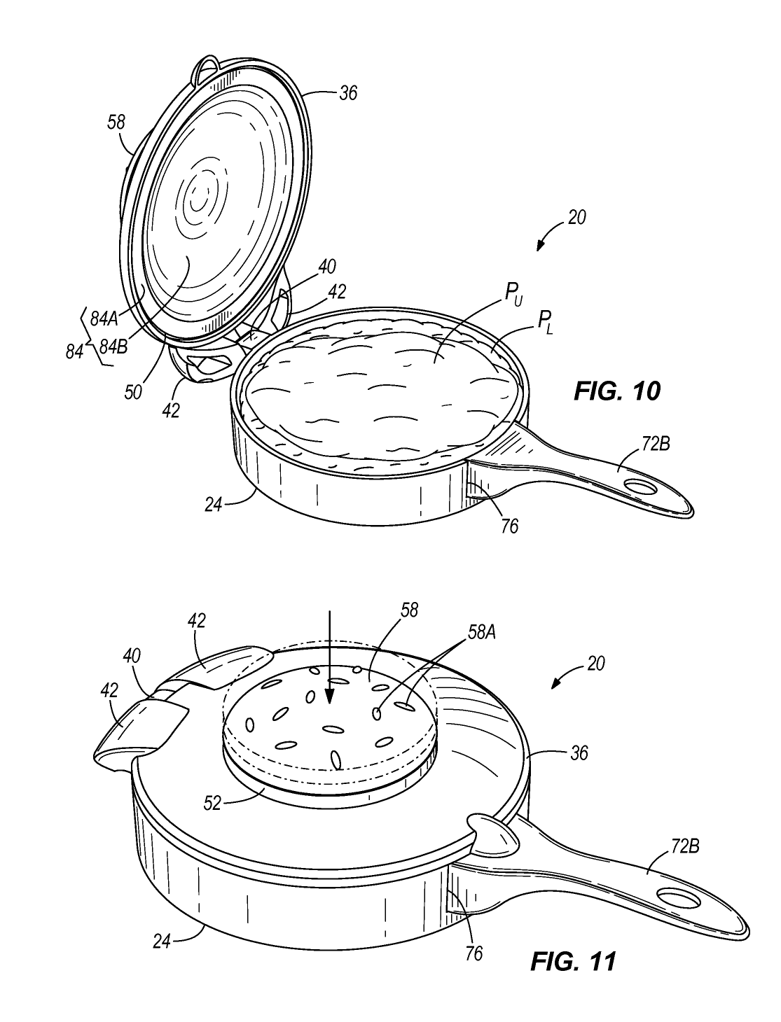

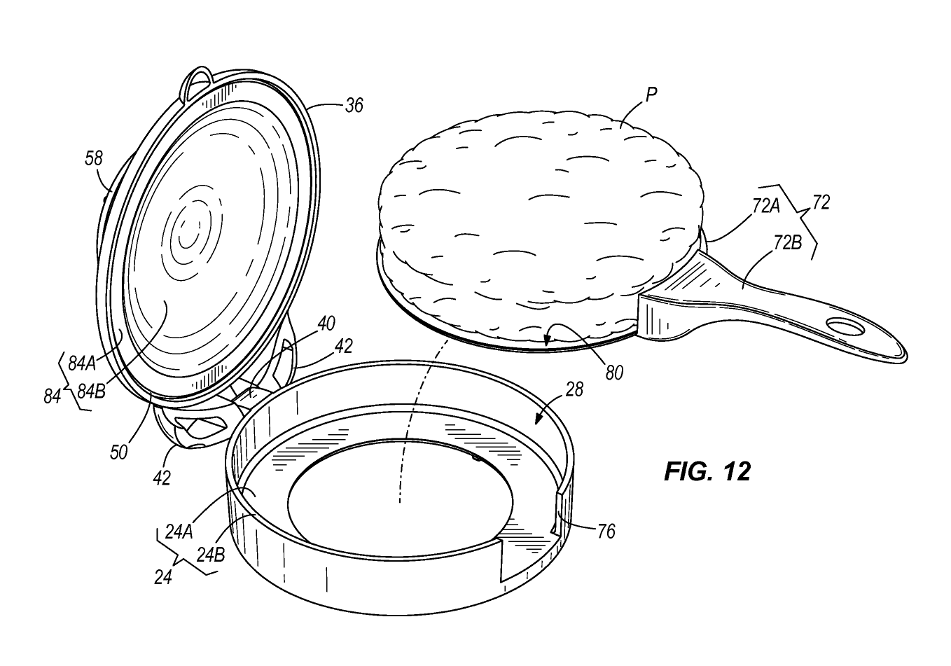

After the lower patty portion P_{L} has been formed with the pocket press 60, the pocket press 60 is removed and one or more stuffing ingredients 104 are placed into the pocket 100 of the lower patty portion P_{L} as shown in FIG. 9. The stuffing ingredients 104 can include, but are not limited to at least one of cheese, vegetables, and condiments. When the desired amount of stuffing ingredients 104 have been placed into the pocket 100 of the lower patty portion P_{L}, a second or upper patty portion Pᵤ is positioned over the lower patty portion P_{L} as shown in FIG. 10. The upper patty portion Pᵤ may be about equal in weight to the lower patty portion P_{L} (e.g., about 2-3 ounces), and need not be meticulously formed. The lid 36 is moved to the closed position so that the stamp 50 is positioned over the upper patty portion Pᵤ, and the cavity 28 is substantially enclosed. As shown in FIG. 11, the stamp actuator 52 is depressed after the lid 36 is closed. When the stamp actuator 52 is depressed, the stamp 50 is moved toward the patty support 72, reducing the volume of the cavity 28 to compress and amalgamate the upper and lower patty portions Pᵤ, P_{L} to form a stuffed patty P, shown in FIG. 12. The stuffed patty P is removed from the cavity 28 by lifting the patty support 72 out of the base 24 with the handle portion 72B. The stuffed patty P may be conveniently transferred via the patty support 72 directly to a dish or a cooking surface, such as a frying pan or a grill.

Various features and advantages of the invention are set forth in the following claims.

What is claimed is:

1. A tool for forming stuffed patties, the tool comprising:
a base defining a cavity;
a lid coupled to the base and movable relative to the base between a closed position in which the cavity is substantially closed, and an open position in which the cavity is substantially open; and
a stamp coupled to the lid and movable relative to the lid when the lid is in the closed position to reduce a volume of the cavity.

2. The tool of claim 1, further comprising a pocket press having a convex portion movable into the cavity to form a pocket in a patty portion positioned in the cavity.

3. The tool of claim 2, wherein the pocket press is not coupled to the base or the lid.

4. The tool of claim 1, further comprising a patty support having a support portion removably received in the base and configured to support the patty portion positioned in the cavity.

5. The tool of claim 4, wherein the support portion includes an upper surface for receiving the patty portion, and at least a portion of the upper surface is concave.

6. The tool of claim 5, further comprising a pocket press having a convex portion movable into the cavity to form a pocket in a patty portion positioned in the cavity, wherein the concavity of the upper surface of the support portion of the patty support defines a depth that is about half as much as a depth defined by the convex portion of the pocket press.

7. The tool of claim 4, wherein the patty support includes a handle coupled to the support portion and extending outside the cavity when the support portion is positioned inside the cavity.

8. The tool of claim 7, wherein the handle extends through a notch formed in a side wall of the base when the support portion is positioned inside the cavity.

9. The tool of claim 1, wherein the stamp has a stamping surface facing generally away from an interior side of the lid and toward the cavity when the lid is in the closed position.

10. The tool of claim 9, wherein at least a portion of the stamping surface is concave.

11. The tool of claim 10, wherein the stamping surface includes a concave central portion and a rim portion that is substantially flatter than the concave central portion.

12. The tool of claim 9, wherein the stamp is biased toward the interior side of the lid.

13. The tool of claim 12, further comprising a stamp actuator movable relative to the lid and coupled to the stamp, and a biasing member positioned between the lid and the stamp actuator to bias the stamp toward the interior side of the lid.

14. A tool for forming stuffed patties, the tool comprising:
a base defining a cavity;
a lid coupled to the base and movable between a closed position in which the cavity is substantially closed, and an open position in which the cavity is substantially open;
a stamp movable with the lid and configured to extend into the cavity when the lid is in the closed position; and
a patty support including a support portion and a handle, the support portion being removably received in the base.

15. The tool of claim 14, wherein the stamp is movably coupled to the lid to reduce a volume of the cavity when the lid is in the closed position, and the stamp is biased toward an interior side of the lid.

16. The tool of claim 15, further comprising a stamp actuator movable relative to the lid and coupled to the stamp, and a biasing member positioned between the lid and the stamp actuator to bias the stamp toward the interior side of the lid.

17. The tool of claim 14, wherein the stamp has a stamping surface facing generally away from an interior side of the lid and toward the cavity when the lid is in the closed position.

18. The tool of claim 17, wherein at least a portion of the stamping surface is concave.

19. The tool of claim 18, wherein the stamping surface includes a concave central portion and a rim portion that is substantially flatter than the concave central portion.

20. The tool of claim 14, wherein the handle extends through a notch formed in a side wall of the base when the support portion is positioned inside the cavity so that the handle extends outside the cavity.

21. The tool of claim 14, wherein the support portion of the patty support includes an upper surface for receiving the patty portion, and at least a portion of the upper surface is concave.

22. The tool of claim 21, further comprising a pocket press having a convex portion movable into the cavity to form a pocket in a patty portion positioned in the cavity, wherein the concavity of the upper surface of the support portion of the patty support defines a depth that is about half as much as a depth defined by the convex portion of the pocket press.

23. The tool of claim 14, further comprising a pocket press having a convex portion movable into the cavity to form a pocket in a patty portion positioned in the cavity.

24. The tool of claim 22, wherein the pocket press is not coupled to the base or the lid.

25. A method of using a patty-forming tool to prepare a stuffed patty, the method comprising:
placing a patty support into a cavity defined by a base of the tool;
placing a lower patty portion into the cavity on the patty support;
forming a pocket in the lower patty portion positioned in the cavity;
placing at least one filling ingredient into the pocket of the lower patty portion;
placing an upper patty portion over the lower patty portion in the cavity;
closing a lid of the tool to substantially close the cavity, the lid having a stamp movably coupled thereto; and
pressing a stamp actuator to move the stamp relative to the lid to reduce a volume of the cavity, thereby bearing on the upper patty portion to amalgamate the upper and lower patty portions and the at least one filling ingredient into a stuffed patty.

26. The method of claim 25, wherein forming the pocket in the lower patty portion positioned in the cavity includes depressing a pocket press having a convex portion onto the lower patty portion in the cavity.

27. The method of claim 25, further comprising using a handle of the patty support to lift the patty support and the stuffed patty out from within the cavity of the base.
